(19) United States
(12) Patent Application Publication
(10) Pub. No.: US 2009/0150435 A1
(43) Pub. Date: Jun. 11, 2009

(54) DYNAMIC UPDATING OF PERSONAL WEB PAGE

(75) Inventors: Suresh Balu, Atlanta, GA (US); Solomon Michael Bisker, Fort Meyers, FL (US); Zahir Dossa, Boston, MA (US); Hyduke Noshadi, Northridge, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/953,021

(22) Filed: Dec. 8, 2007

(51) Int. Cl. G06F 17/30

(52) U.S. Cl. 707/104.1; 707/E17.005

(57) ABSTRACT

A user's personal home page can be dynamically updated by desired content originating on external web pages as long as the content continues to occupy the same position on the external web page. The owner of the personal home page configures the update system by specifying at least the network path to each selected web page, the pixel coordinates of the desired content on the selected web page, the pixel coordinates at which the desired content is to appear on the personal home page. The external selected web pages are pushed or pulled to the user's system where the desired content is extracted and written into a video buffer. Once in the video buffer, the content can be used to update the personal home page.

### BACKGROUND OF THE INVENTION

The present invention relates techniques for allowing an Internet user to more easily build a personal home page on the user's own personal computer and more particularly to techniques for allowing such a user to more easily dynamically update the contents of the personal home page by including data acquired from existing pages at external sites on the World Wide Web.

### BRIEF SUMMARY OF THE INVENTION

The invention may be implemented as a method of dynamically updating a video page. A generated video page includes at least one updatable region. A source video page having a source region occupying a predetermined location is associated with the updatable region. The current contents of the source region are periodically retrieved and written into the updatable region of the generated video page.

The invention may also be implemented as a system for dynamically updating a video page. The system would include a monitor for presenting a visual display of the dynamically updatable video page and a video buffer for storing video data to be presented on the monitor. The video buffer would have at least one region allocated to dynamically updatable video data. A source control module would associate the buffer region with a source region occupying a predetermined location on a source video page. An acquisition module would periodically retrieve the current contents of the source region. A buffer control module would write the retrieved current contents into the region of the video buffer.

The invention may also be implemented as a computer program product including a computer usable medium having computer usable program code embodied therewith. The embodied program code would include program code for generating a video page having an updatable region. It would also include program code for establishing an association between a source region occupying a predetermined location on a source video page with the updatable region on the generated video page. It would further include program code for periodically retrieving the current contents of the source region and writing the retrieved contents into the updatable region of the generated video page.

### BRIEF DESCRIPTION OF THE SEVERAL VIEWS OF THE DRAWINGS

FIG. 1 is a graphical representation of major components of systems involved in the implementation and use of the present invention.

FIG. 2 is a schematic representation including details of the functional infrastructure of a user's system that can practice the present invention.

FIG. 3 is a schematic representation used as part of an explanation of an implementation of the present invention.

FIG. 4 is a block diagram of the major elements of a system embodiment of the present invention.

FIG. 5 is a flow chart of major steps in a configuration process.

FIG. 6 is a flow chart of major steps in the a “pull” model implementation of the present invention.

FIG. 7 is a flow chart of major steps in a “push” model implementation of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

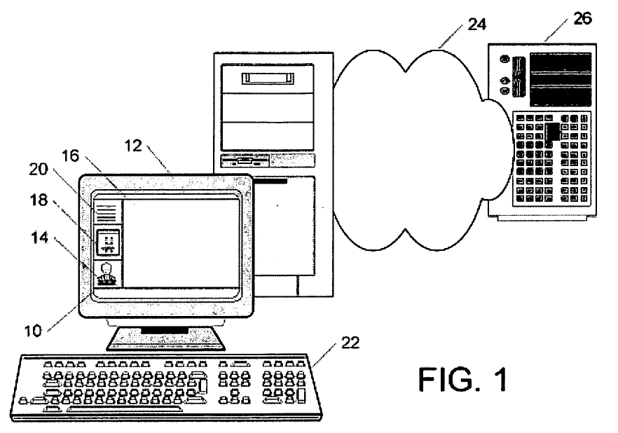

With reference now to FIG. 1, a personal computer user may desire to establish a “web presence” by means of a personal home page that is visible to any other personal computer user visiting the first user's web page. The personal web page, of course, appears on the display screen 10 of a personal computer system monitor 12. The contents of the personal web page are under the control of the first user and may include a personal photograph of the user in a small frame 14 along with some autobiographical information. On a good number of personal home pages, a major area 16 is dedicated to a blog or running commentary written by the user. The majority of computer users who maintain blogs employ them as a forum to convey their likes and dislikes to the rest of the world. For example, some users may be passionate fans of a particular sports team, such as the New York Yankees, and will ramble on about their favorite team at lengths that may seem reasonable only to other fans of the same team.

A computer user may want to do more than maintain a personal blog focused on a favorite sports team or a favorite hobby. A sports fan may want to provide the latest scores or statistics for his team in a frame 18 on the personal home page screen or the most recent team press releases in another frame 20 in the personal home page.

While the user can obtain this kind of information via television or radio broadcasts or by web surfing and then key it in the system through keyboard 22, this approach requires a significant effort from the user as well as constant attention to the personal home page. It would be much easier for the user if the desired information could be acquired via the Internet 24 from one or more remote servers, represented in the drawing by remote server 26, on which the information is already made available to Internet users and then used to automatically (i.e., dynamically) update the personal home page without direct user involvement.

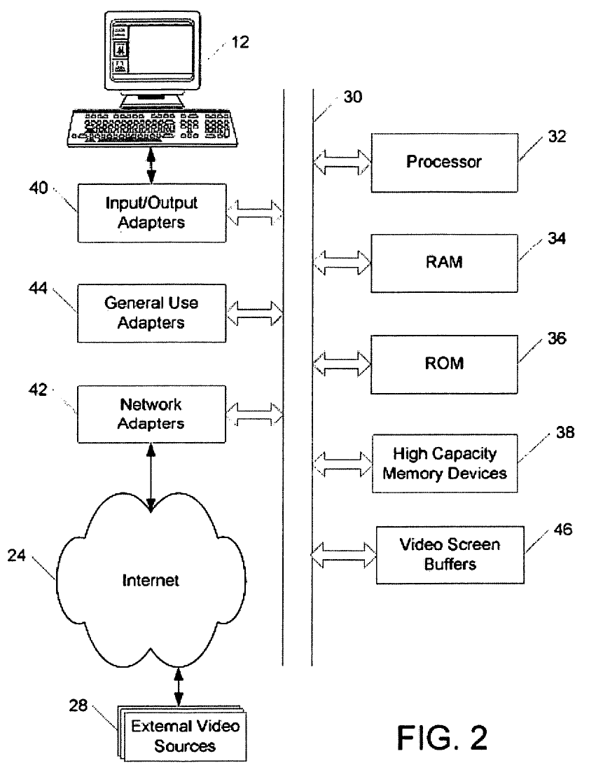

FIG. 2 illustrates a functional infrastructure for a personal computer system that can be programmed to automatically acquire desired content from external video sources 28 via the Internet 24 and to then use that content to dynamically update a personal home page that appears on a monitor 12 in a personal computer system.

The personal computer system includes a system bus 30 used to interconnect elements of the infrastructure such as processor 32, random access memory (RAM), read only memory (ROM), high-capacity memory devices 38, examples of which are magnetic hard drives and/or optical CD or DVD drives, input/output adapters 40, network adapters 42 that provide the connection to the external video sources 28 through the Internet 24, and general use adapters 44 that can be used for a variety of purposes. Examples of general use adapters are USB or Firewall adapters that can be used to connect a variety of external devices, including but not limited to backup hard drives, fingerprint readers, printers, and wireless transceivers, etc., to the system bus 30 in the personal computer system.

In implementing the present invention, the personal computer system may also include dedicated video screen buffers 46 used to store video content captured or grabbed from specified external video sources 28. The role of the video screen buffers is described in greater detail below.

The present invention stems from a realization that useful content can be acquired from external sources via the Internet without the use of markup languages, source code or application programming interfaces (APIs) for the external sources. If the external source is represented as a video display on a computer display screen and if the content that is to be acquired always occupies the same region on that display screen, the content can be acquired by “grabbing” the screen image, designating the coordinates of the pixels that convey the desired content, storing those pixels in a video screen buffer and then writing them into a “hole” or region reserved in the personal home page for the external content.

As an example, assume the personal computer user is a New York Yankees fan who knows that the Yankees maintain a website with a home page configured for display at a resolution of 1024×768 pixels and that the screen always includes a rectangular frame that displays the scores of recently played games. By detecting the screen position of a cursor, the user can establish that the top left corner of the frame always appears at a pixel position of x=0, y=240 while the bottom right corner of the frame always appears at a pixel position of x=256, y=288.

Armed with this information, the personal computer user can configure the computer system to periodically acquire the web page including the desired scores, acquire the content bounded by pixel ranges 0≦x≦256 and 240≦y≦288, and write the content into an associated video buffer. The acquired content can then be used to refresh a dedicated region on the personal home page.

A user need not be limited to acquiring content from a single external source. Content from multiple sources can be obtained as long as the user knows the address of each source page and the pixel coordinates for the desired information on the source page. Moreover, it is not necessary that the acquired content occupy the same relative position on the target or personal home page that it occupies on the source page. All that is necessary is that the personal home page has a dedicated region associated with the external content to be displayed and that the dedicated region have the same horizontal and vertical pixel dimensions as the source frame for the content on the external source screen. That is, if the external source originally displays the content in a box 256 pixels wide and 48 pixels high, the personal home page must also have a region somewhere on the home page that is 256 pixels wide and 48 pixels high and is dedicated to displaying the desired content.

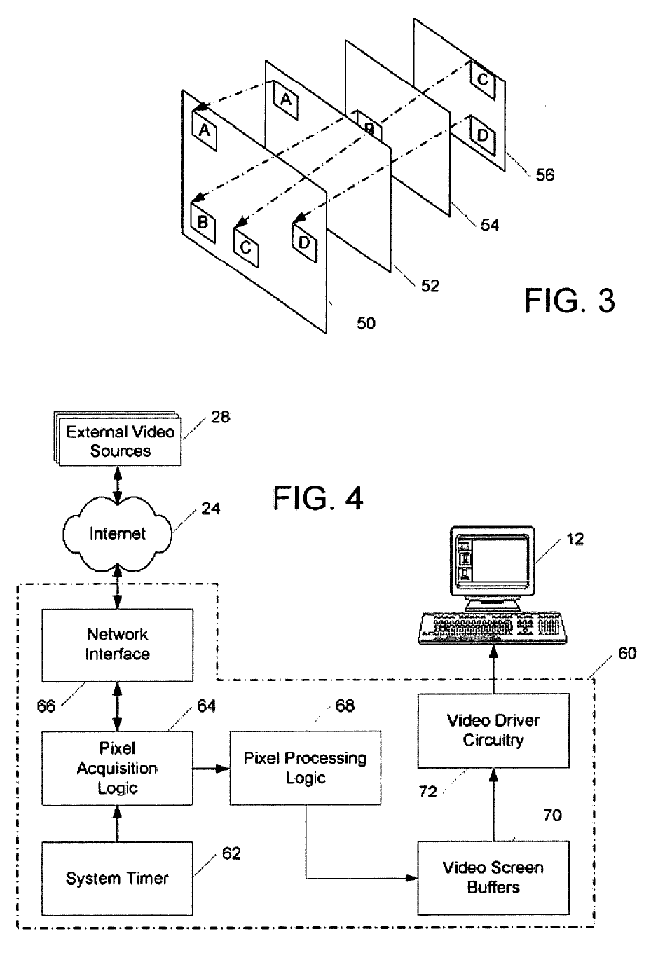

FIG. 3 illustrates the concepts discussed above. Assume a personal home page screen 50 includes four regions A, B, C, and D populated by content from three different external sources represented by screens 52, 54 and 56. The owner of the personal home page must know the Internet address for each of the source pages or screens and the pixel coordinates on those screens of the content that is to be acquired and displayed on the personal home page. In the illustration, the region A on external source screen 52 and the corresponding region A on personal home page 50 occupy the same relative positions on the two screens. Similarly, the region B on external source screen 54 has the same pixel coordinates as the corresponding region on personal home page 50. On the other hand, regions C and D on external source screen 56 do not appear on the same areas of the source screen as do corresponding regions C and D on personal home screen 50. That causes no problems as long as the region C on personal home page 50 has the same horizontal and vertical pixel dimensions as region C on the external source screen 56 and the region D on screen 50 has the same horizontal and vertical pixel dimensions as region D on screen 56.

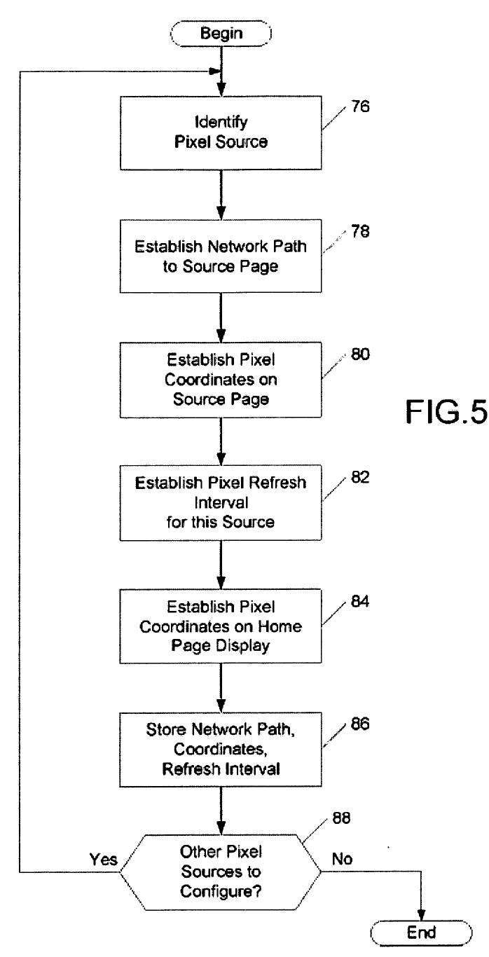

While the present invention is most likely to be implemented by programming a general-purpose computer, such as a personal computer, it can be implemented as a dedicated system comprising a combination of special-purpose hardware, firmware or microcode and perhaps conventional software. FIG. 4 illustrates the major components of a dedicated system 60 that can be used to acquire desired content from the external video sources 28 via the Internet 24 for presentation on monitor 12.

The dedicated system 60 includes a system timer 62 for controlling the timing of operations, including the acquisition of the external content from external video sources 28. System timer 62 controls pixel acquisition logic 64 that is used to establish connections to the external video sources 28 through a network interface 66. The external content acquired from the external video sources 28 is retrieved through network interface 66 and sent to pixel processing logic 68 that isolates the desired content from the remainder of the external video screen and sends only the desired content to via screen buffers 70. The desired content is combined with other locally generated content in video driver 72 before being written to the monitor 12.

In order to operate properly, both a programmed general-purpose computer system and a dedicated system have to be configured. The configuration process is illustrated at a high level in a flowchart in FIG. 5. The first step 76 in the configuration process is to identify the external source from which desired content is to be acquired. The owner of the personal home page normally identifies each external source via keyboard input to the system.

Once the external source is identified, the full network path to that source is established in step 78. The network path in most cases is likely to be a conventional URL or Universal Resource Locator.

After establishing the path to the external source, the pixel coordinates of the desired content on the source page are established in step 80. One simple way to establish the coordinates is for the system user to first position the cursor at the top left corner of the source frame having the desired content, perform a mouse click operation which can be translated into the x and y coordinates of the cursor position, move the cursor to the bottom right corner of the source frame and repeat the operation.

In the next step 82, a decision is made as to how frequently the personal home page is to be updated with information acquired from the external source; that is, what the source refresh interval is to be. In step 84, the pixel coordinates for the home page region at which the acquired content is to be displayed must be established by the user.

Once the preceding steps are completed, the network path, the source pixel coordinates, the home page pixel coordinates and the refresh interval are stored in the local system in a step 86. Following the storage step, a check is made in step 88 as to whether other additional external sources need to be configured. If there are more external sources to be configured, the program loops back to operation 76. If there are no additional external sources to be configured, the configuration process is terminated.

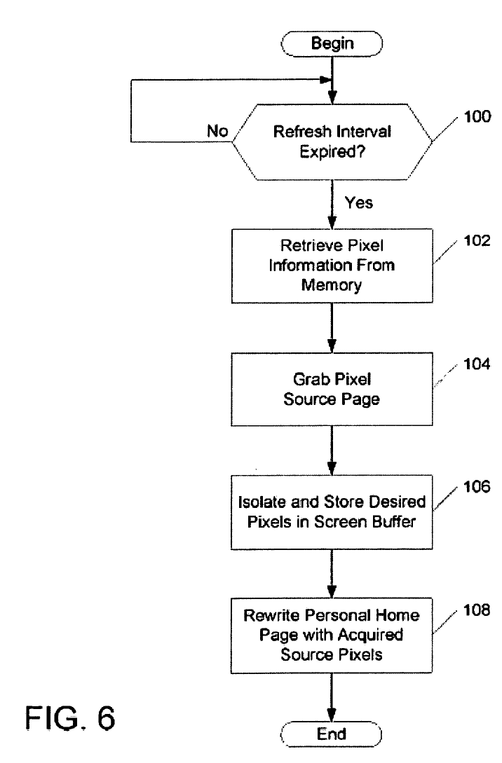

The above description assumes a “pull” model is used to control the dynamic update process in either a programmable general-purpose computer system or a dedicated system. FIG. 6 is a basic flowchart of a “pull” model. For each configured external source, a system timer monitors the amount of time since the last refresh operation involving that source in a wait loop 100. Once the refresh interval for the source has expired, the information needed to perform a new refresh operation is retrieved from local system memory in an operation 102. As noted earlier, that information includes the network path to the external source, the pixel coordinates of the desired content at the external source and the pixel coordinates at which the desired content is to be written on a personal home page. The entire external source page is grabbed in step 104 before the desired content from that page is isolated and stored in the screen buffer in step 106. The information stored in the screen buffer is used to update the personal home page with the newly acquired content from the external source in a step 108.

It will be noted that in the update process is shown as being performed on a source-by-source basis, which makes sense where different sources have different refresh intervals. System programming could be simplified somewhat if it were decided to have the same refresh interval for all external sources. In that case, the process described with reference to FIG. 6 could be iterated for each of the selected external sources.

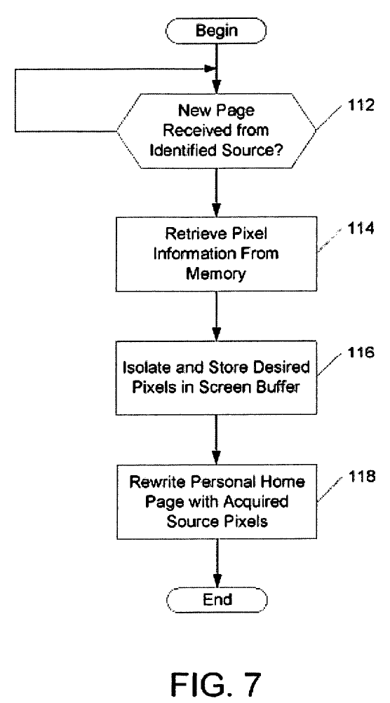

In an alternate embodiment, the invention is implemented by using an external content server (not shown) to “push” source updates to the local system. The “push” model shown in FIG. 7 does not require the use of a timer capable of tracking a refresh interval. In this model, the local system receives unsolicited external source updates delivered (i.e., pushed) to the system by the external source. The local system is notified of a new page in step 112 and responds to the notification by retrieving the pixel coordinate information for both the source and the home page from local memory in a step 114. There is no need to retrieve network path information as it is assumed the entire external source page already exists in local memory.

The retrieved coordinates are used to isolate the desired contents from the external source page before storing those contents in a screen buffer in step 116. The final step is to rewrite the personal home page with the newly acquired content in step 118.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of dynamically updating an output video page comprising:
a) defining one or more updatable regions in the output video page;
b) identifying one or more source video pages, each source video page having a source region;
c) associating each source region with one of said updatable regions of said output video page;
c) periodically retrieving the current contents of each source region; and
d) periodically writing the retrieved current contents of each source region into the associated updatable region of the output video page.

2. A method according to claim 1 wherein periodically retrieving the current contents of each source region further comprises:
a) establishing a refresh interval for each of the one or more source video pages;
b) upon expiration of a refresh interval for a source video page, acquiring the source video page, isolating the current contents of the source region on the acquired source video page and storing the current contents.

3. A method according to claim 1 wherein associating each source region with one of said updatable regions of said output video page further comprises:
a) specifying an address for the source video page; and
b) identifying the location of the source region within the source video page.

4. A method according to claim 2 wherein the location of the updatable region in the generated video page is defined by a starting pixel location on the generated video page, a horizontal pixel dimension and a vertical pixel dimension.

5. A method according to claim 3 wherein the location of the source region of the source video page is defined by a starting pixel location on said source video page, a horizontal pixel dimension and a vertical pixel dimension.

6. A method according to claim 5 wherein the horizontal pixel dimension and vertical pixel dimension of the updatable region are equal to the horizontal pixel dimension and vertical pixel dimension of the source region.

7. A system for dynamically updating an output video page comprising:
a) a monitor for presenting a visual display of the dynamically updatable video page;
b) a video buffer for storing video data to be presented on the monitor, said video buffer having at least one updatable region allocated for dynamically updateable video data;
c) a source control module for associating the updatable region with a source region occupying a predetermined location on a source video page;
d) an update acquisition module for periodically retrieving the current contents of the source region; and
e) a buffer control module for writing the retrieved current contents into the updatable region of the video buffer.

8. A system according to claim 7 wherein the source control module includes a storage module for storing an address for the source video page and the location of the source region on the source video page.

9. A system according to claim 8 wherein the location of the source region on the source video page is stored as a starting pixel location on the source video page, a horizontal pixel dimension and a vertical pixel dimension.

10. A computer program product for dynamically updating an output video page, the computer program product comprising a computer usable medium having computer usable program code embodied therewith, the computer usable program code comprising:
a) computer usable program code configured to define one or more updatable regions in the output video page;
b) computer usable program code configured to identify one or more source video pages, each source video page having a source region;
c) computer usable program code configured to associate each source region with one of said updatable regions of said output video page;
c) computer usable program code configured to periodically retrieve the current contents of each source region; and
d) computer usable program code configured to periodically write the retrieved current contents of each source region into the associated updateable region of the output video page.

11. A computer program product according to claim 10 wherein the computer usable program code configured to associate each source region with one of said updatable regions of said output video page further comprises:
a) computer usable program code configured to specify an address for the source video page; and
b) computer usable program code configured to identify the location of the source region within the source video page.

12. A computer program product according to claim 11 wherein the location of the updatable region in the generated video page is defined by a starting pixel location on the generated video page, a horizontal pixel dimension and a vertical pixel dimension.

13. A computer program product according to claim 12 wherein the location of the source region of the source video page is defined by a starting pixel location on said source video page, a horizontal pixel dimension and a vertical pixel dimension.

14. A computer program product according to claim 12 further including computer usable program code configured to establish a refresh interval for each source region.

15. A computer program product according to claim 13 further including computer usable program code configured to establish a refresh interval for each source region.

16. A computer program product according to claim 15 wherein the computer usable program code configured to periodically retrieve the current contents of each source region further comprises:
computer usable program code configured to detect the expiration of the refresh interval for the source region;
computer usable program code configured to retrieve the network path to the source video page; and
computer usable program code configured to access the source video page.
